(19) United States
(12) Patent Application Publication
(10) Pub. No.: US 2008/0300704 A1
(43) Pub. Date: Dec. 4, 2008

(54) Method and process for producing personalized ornamental bulbs

(76) Inventors: Laurie Watkins, Melbourne Beach, FL (US); William W. Watkins, Melbourne, FL (US)

Correspondence Address: Kevin T. Price, Suite A, 1402 Highway A1A, Satellite Beach, FL, 32937, US

(21) Appl. No.: 12/154,083

(22) Filed: May 20, 2008

Related U.S. Application Data
(60) Provisional application No. 60/939,242, filed on May 21, 2007.
(60) Provisional application No. 60/940,236, filed on May 25, 2007.

(51) Int. Cl. G06F 19/00

(52) U.S. Cl. 700/98

(57) ABSTRACT

A method and system for producing a personal ornamental product and a custom 3D color or monochrome sculpture incorporated into the ornamental product as a keepsake ornament. The method includes the collecting three-dimensional data from one or more sensors, adjusting the 2½D or 3D data, merging the 2½D or 3D data to produce a 2½D or 3D model, rectifying the model, preparing the sculpture for building, combining the sculpture with a bulb, producing the product with a rapid prototype device, and finishing the product. The ornamental product may be composite, porcelain, ceramic, glass, metal, etc. and often takes the form of a Christmas Tree Ornament but also may be very large and designed for table top display or otherwise.

### RELATED APPLICATIONS

This application claims the benefit of U.S. Provisional Application No. 60/939,242 filed on May 21, 2007 and U.S. Provisional Application No. 60/940,236 filed on May 24, 2007 which are incorporated herein by reference.

### FIELD OF THE INVENTION

This invention relates to methods for producing three dimensional ornamental objects and in particular to methods for producing a personal ornamental product with a custom three-dimensional sculpture incorporated into the ornamental product as a keepsake ornament.

### BACKGROUND AND PRIOR ART

Known prior art includes four U.S. Patent Publications and twelve U.S. Patents. U.S. Patent Publication No. 2007/0070627 describes a decoration device that may include a backlit flat panel inside an interior space of the structure. The flat panel may include a decorative scene that is viewable from outside the ornament structure, and one or more light sources may be substantially aligned with certain elements of the scene (e.g., candles, a fireplace, stars, or the like) so that those elements have the appearance of emitting light that illuminates other portions of the decorative scene.

U.S. Patent Publication No. 2005/0175793 discloses a thin-walled, blown glass ornament that can be repeatedly opened and closed. The ornament includes a spherical, spatial body consisting of at least a top and bottom module jointly connected with each other with an articulating hinge or elastic band and at least one lock situated on the rim of each module. The bottom module may have a flat bottom. At least one additional miniature ornamental object is situated inside the ornament that opens and both modules may also be connected with locks.

U.S. Pat. Nos. 4,309,464, 4,224,364, 4,173,667, 3,802,104 and 3,565,735 describe personalized decorative ornaments having a picture embedded in a flat side, having a flat interior surface for a picture and a window for viewing the picture or other object placed inside the ornament. Decorative ornaments of the type having a three-dimensional core, usually of molded polystyrene material, with a smooth exterior surface covered by high sheen strand material spirally wound about the core are known and provide exceptional decorative quality and many advantages over prior ornaments, particularly of the decorated glass type. The '464 patent discloses a decorative ornament having personal significance to the user. The ornament includes high sheen strand material spirally wound about the smooth exterior surface of a three dimensional core, a barrier coating covering the windings and the exterior surface, a sheet of flexible, conformable material secured to said barrier coating and bearing a photograph or object having a personal significance to the user.

U.S. Patent Application Publications Nos. 2006/0025878 and 2001/0044668 describe prototyping three-dimensional images for producing cavities or molds for producing a three-dimensional object using linearly moved scanning. Digitized measurements are converted and transferred to work stations for editing and sending to a milling machine.

U.S. Pat. No. 7,079,914 discloses a system useful in producing a three-dimensional body comprising bone or tissue-compatible material includes a detection and analysis site which identifies and simulates a portion of a body in connection with an implantation situation. A production device produces a model responsive to the simulation information. A flame-spraying apparatus provides the bone-compatible and/or tissue-compatible material in a powder form through a nozzle. Movements of a nozzle and/or a supporting member are controlled so as to affect a desired surface characteristic on the three-dimensional body.

U.S. Pat. No. 6,898,477 discloses a method which includes the step of reading a rapid prototyping build file that stores a digital description of a three dimensional object. The '477 patent also includes the operation of selecting a build file correction algorithm from a plurality of build file correction algorithms. Defects in the rapid prototyping build file are identified and these defects are then corrected based on the selected build file correction algorithm.

U.S. Pat. No. 6,568,455 discloses a method for making personalized jewelry which digitally captures an image of a person or other object. The image is saved as a digital profile and processed to create a numerical profile. The mold is then used in a casting process wherein the mold is injected with precious, semi-precious, or base metals to make a cast of the object.

U.S. Pat. No. 6,549,819 discloses a method of producing three-dimensional copies of individual human faces and heads is provided that employs a method of production in which all of the components except for the face area are standardized. U.S. Pat. No. 5,736,201 discloses a process for making a doll's head looking like the head of a living person by rotating the person on a first rotatable support and scanning the rotating head with respect to both topography and color. U.S. Pat. No. 5,543,103 discloses a process of surface shaping involving creating an accurate three-dimensional depiction of an object; selection a portion of said three-dimensional depiction; and incorporating said selected portion as an integral part of a wall surface.

U.S. Pat. No. 5,363,159 discloses a three-dimensional photographic technique comprises scanning the outside surface of the three-dimensional surface such as a human subject using a color digitizer which generates spatial and color data relating to the outside surface. The spatial data is used to generate a mold. The photographic material is applied on the inside surface of the hollow shell and is exposed using an image manipulation system and fiber optic transportation system which extracts the light from a screen and transmit it to a position adjacent the outside surface of the hollow shell to provide the required colored image on the photographic material for display through the transparent material of the hollow shell.

### SUMMARY OF THE INVENTION

A primary objective of the invention is to provide methods, apparatus and systems for producing a personal ornamental object and three-dimensional sculpture digitally generated to produce a personalized ornamental product.

A secondary objective of the invention is to provide methods, apparatus and systems for combining three-dimensional models to produce a digital sculpture and a digital bulb.

A third objective of the invention is to provide methods, apparatus and systems for monolithically producing personalized sculptures and ornamental products such as an ornamental bulb, vase or vessel.

A fourth objective of the invention is to provide methods, apparatus and systems for finishing an ornamental product such as an ornamental bulb, vase or vessel.

A first preferred embodiment of the invention includes a method of collecting three-dimensional (3D) data from one or more sensors, adjusting the three-dimensional data and merging the three dimensional data to produce a three-dimensional model, rectifying the model, preparing the sculpture for building, combining the sculpture with a bulb, producing a personalized ornamental product and finishing the product.

Further objects and advantages of this invention will be apparent from the following detailed description of preferred embodiments which are illustrated schematically in the accompanying drawings. Other embodiments of the invention include removing erroneous measurements from the three-dimensional data, eliminating unwanted data; and adjusting colors of the three-dimensional data by numerous means. Another embodiment includes a method of combining at least two sets of three-dimensional data into a single model. And in yet another embodiment, a method integrates images associated with three-dimensional digital models into a single picture.

### BRIEF DESCRIPTION OF THE FIGURES

FIG. 1a shows an example of an ornamental bulb having a three-dimensional figure within the ornamental bulb.

FIG. 1b is a back view of another example of an ornamental bulb for providing a backlight.

FIG. 2 is a flow diagram showing the steps for fabricating a personalized ornamental product.

FIG. 3 is a flow diagram showing the steps of adjusting 2½D or 3D data.

FIG. 4 is a flow diagram showing the steps of adjusting colors.

FIG. 5 shows the various preparation techniques to produce an ornamental product.

FIG. 6 shows the selection of material for the ornamental product.

### DESCRIPTION OF THE PREFERRED EMBODIMENTS

It would be useful to discuss the meanings of some words used herein and their applications before discussing the methods, uses, and applications of invention including:

Texture is the image that is attached to the 3D digital model. By way of example the texture of a sculpture of a person is essentially a picture or a composite of pictures that is mapped to the 3D digital model. Texture is a term commonly used in the industry. Many data formats commonly store the texture in a separate file (such as .bmp, .jpg, .gif tiff, etc.) and associate the images with the 3D data. The texture may also be stored within the same file as the 3D data, formats such as .zpr, or .zbd, .ply etc. hold a picture internally. Those skilled in the art will understand that there are many file formats that either store the texture internally or store the texture separately.

The terminology of 2½D is a digital representation of a model that has no thickness and/or has not been closed. A closed surface is considered to be 3D. A simple example of something that is 2½D is the digital surface representation of a person's face which does not include the entire head. If the model of the head is closed, such as creating a bust, then that data is considered 3D. Once an object becomes real (or is built) then the model cannot be 2½D because it truly has some volume. Steps that can be done in 2½D can also be done in 3D or more dimensions. Throughout the following description, when the term 2½D is used it is considered 2½D or 3D.

Open is a term that is used to mean that the digital data does not have any thickness and is not closed. For example, conceptually if the open digital data were filled with a liquid it would leak or spill if turned. A contour is a specific example of an open model. For physical objects “open” denotes an object that when filled with water and turned over the water will flow out. A bowl is an example of an open real object. A “closed” digital model is a model that has no holes. For digital models a contour that has some thickness (or shell) is considered closed. For a physical model closed usually refers simply to a completed volumetric model such as a solid bust.

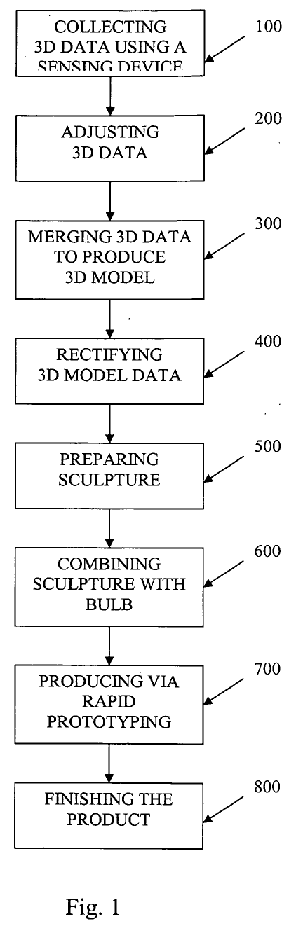

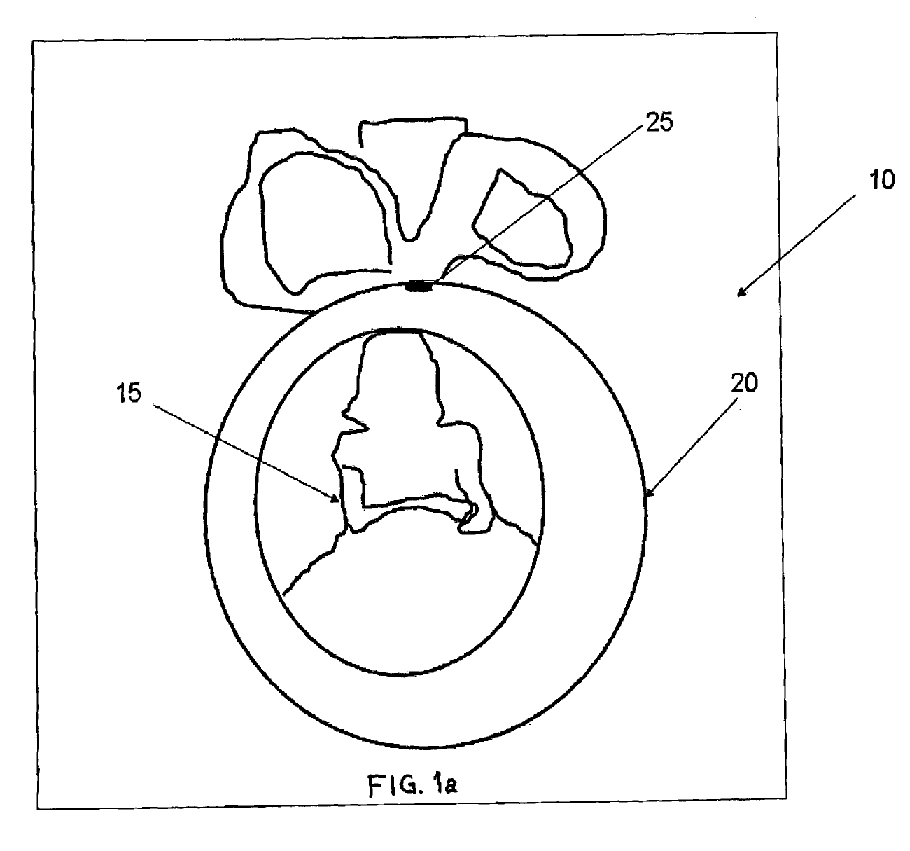

The method and system of fabricating a personalized ornamental product within the present invention is shown in FIGS. 1 through 6. The present invention provides methods for producing a personalized decorative product having a three-dimensional sculpture internally or externally connected to the decorative product. In a preferred embodiment, the decorative product is a hollow ornamental bulb with an opening for viewing the three-dimensional sculpture. In other embodiments the ornamental product may be a large product for display on a table top or other presentation feature, the ornamental product may be made clear with a sculpture inside, or the ornamental product may have clear window for viewing the sculpture.

Alternatively, the decorative product may be a vase or other vessel with a hollow area in one side for viewing a sculpture within the hollow area, the vase or vessel may have the sculpture protruding out of one or more sides, or the sculpture may be integrally formed with the exterior surface of the ornamental product. Similarly, the ornamental product may be a vase or vessel with a sculpture protruding from a side of the vase or vessel. An important feature of the present invention is not the type of ornamental product produced, it is the method of scanning an object selected by the customer, such as a person or pet, then producing the finished ornamental product with a 2½D or 3D sculpture of the object selected. For purpose of example, and not limitation, the following description of the method is illustrated and described for an ornamental bulb. In this example, the ornamental product is a personal ornamental bulb combined with a custom three-dimensional (3D) color or monochrome sculpture.

FIG. 1a shows an example of an ornamental bulb having a three-dimensional figure, a bust, within the ornamental bulb 10. In the example shown, the bulb 20 includes an opening for viewing a three-dimensional FIG. 15 of a person within a hollow cavity of the ornamental bulb. The three-dimensional figure is a customized personal sculpture of a person, an animal, pet, or other living being as a keepsake ornament. In other embodiments, the three-dimensional figure is a customized sculpture of a miscellaneous object such as sporting goods, memorabilia, or other forms of personal property.

In an embodiment, the finished product includes a three-dimensional sculpture with a portion of the sculpture, such as an arm or a foot, extending a distance through the side of the ornamental bulb. In another embodiment, the size of the three-dimensional sculpture within the bulb exceeds the size of the bulb such that the method of producing the bulb is required to be a monolithic build of the ornamental object and sculpture simultaneously. Additionally, the three-dimensional figures or sculptures 15 may be translucent and backlighting of the translucent sculptures also allows for an appealing affect.

The bulb 20 may include an attachment point or hole for hanging the ornamental bulb, or the base of the bulb 20 may be flat (not shown) for standing the ornamental product on a flat surface. FIG. 1b is a back view of another example of an ornamental bulb for providing a backlight 30. The bulb 20 may include an inscription 35 on the back of the bulb as shown, or may include an inscription, such as a name, date or serial number on any exterior surface of the bulb 20. In this example, the bulb may be fabricated from numerous materials, such as porcelain, ceramic, glass, metal, resin, or RP materials.

Within the present invention, digital processing is used to generate a 3D sculpture by scanning a person, animal, or other 3D object. The 2½D or 3D scan data is converted into a usable computer model for producing the sculpture. The sculpture and bulb are then mated either physically or digitally to form a personalized ornamental product.

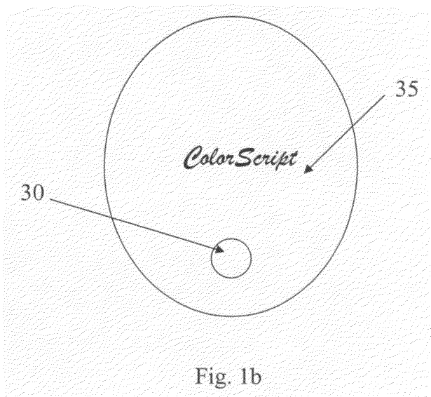

FIG. 2 shows a method of the present invention which includes the steps of collecting 2½D or 3D data 100 from one or more sensors, adjusting or modifying the collected data in step 200, merging the 2½D or 3D collected data from step 100 with the adjusted data from step 200 to obtain a 2½D or 3D digital model data in step 300, in step 400 the 2½D or 3D digital model data from step 300 is rectified the prepared in step 500 for building the sculpture, in step 600 the prepared data from step 500 is combined with a data associated with the selected ornamental object and in step 700 the ornamental product is produce utilizing a rapid prototype device or other equipment 700. In step 800 the ornamental product is finished.

There are numerous methods for collecting 2½D or 3D data in step 100. The techniques vary from using structured light, laser scanners, photogrametry, parallax, digital correlation, including sonar and infrared techniques coupled with cameras for exploiting color. Conceptually collecting data can be done with high frequency radar as well. Additionally, there are an enormous number of highbred solutions where various technologies are combined to achieve specific results. In one embodiment of the present invention, structured light scanners are utilized to collect 3D data. Structured light scanners reliably gather data, perform well on details such as hair, and typically include well established editing tools. However, alternative methods and machines that are currently available or will be available at a future date may be substituted without deviating from the scope of the present invention.

The 2½D or 3D data is adjusted in step 200. Ideally the processing of the collected data produces a highly accurate 3D model at the completion. However, the collected data usually needs to be corrected and adjusted to achieve the desired end result of a high quality 3D color sculpture. There are some instances where the desired product's color or texture might not accurately or correctly correlate with the real data. A simple example of this is when the sculpture is to be produced with a marble texture instead of the person's own image. The 2½D or 3D data collected includes a first object and a second object data. The first object data may include undesirable data such as artifacts, protrusions, uneven surfaces, erroneous measurements, unwanted data, distorted colors and shapes, or objects to be selectively eliminated from the product. The second object data includes data which represents the intended or desired object to be produced.

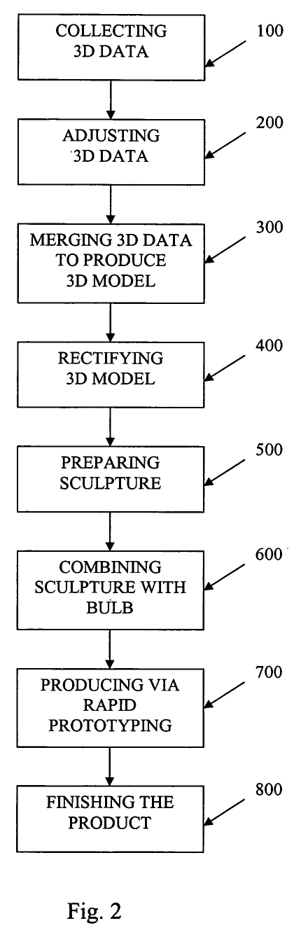

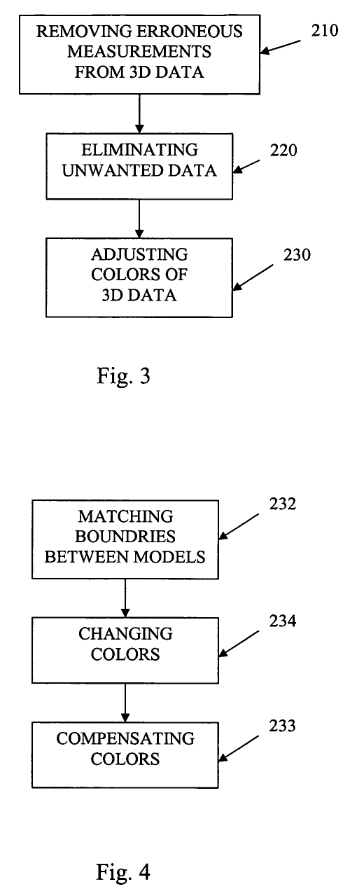

In one embodiment, adjusting the 3D or 2½D data in step 200 includes eliminating the unwanted or first object data from the collected 2½D or 3D data. In another embodiment, adjusting the 3D data includes removing of specific erroneous or unwanted data from the collected 2½D or 3D data 210 as shown in FIG. 3, which includes eliminating undesirable data corresponding to objects that were scanned but not wanted 220, and adjusting colors of the data 230. In yet another embodiment of the present invention and using FIG. 4, colors may be adjusted by matching boundaries between individual models 232, changing colors 234 to create a more appealing ornamental product, and compensating colors 236 to match deficiencies in the processing chain which may present colors vividly or vaguely.

Referring back to FIG. 2, the adjusted 2½D or 3D data is merged using step 300, which may be performed by combining at least two sets of 2½D or 3D data into a single 2½D or 3D model, or alternately step 300 integrates images associated with the 3D models into a single picture. Some sensors or 2½D or 3D data collectors provide means to automatically merge data. The collected 2½D or 3D data is merged with the adjusted data 300 into a usable model. Once the data are merged into one model, the model data needs to be finalized and prepared for production.

Rectifying the model in step 400 includes correcting and enhancing the merged model data from step 300 that may need repair or modification. Rectifying the 3D model data 400 includes a first surface data and a second surface data which are analyzed for correcting the model data. The first surface data corresponds to undesirable data such as artifacts, protrusions, uneven surfaces, erroneous measurements, unwanted data, distorted colors and shapes, or objects to be selectively eliminated from the product. The second surface data includes data which represents the intended or desired object to be produced. In one embodiment, the first surface data is eliminated from the model data in rectifying step 400.

There are several potential artifacts or sets of undesirable data from the merging process that may require attention. At this stage it is appropriate to correct and enhance the merged texture. A common problem is a visible seam where two textures come together on the composite model. Usually these seams need to blended or otherwise color adjusted to match. A 3D, or 2½D equivalent, seam problem occurs as well. Moreover, other defects become more pronounced in the completed model and need to be repaired, such as closing open holes, correct color and seams, and repair other artifacts.

Therefore, rectifying in step 400 in one embodiment includes repairing flaws in the 2½D or 3D merged model data and removing data associated with shadows within the image or model. In some embodiments of the present invention, closed models (e.g., entire 360 degree) are created for the sculpture; in others only a 2½D surface of the front and sides of the individual or object is generated. For these situations, an open surface has no thickness and cannot be built. Therefore, these open surfaces are resolved by the rectifying step 400 which extrudes the edges towards the back of the subject and closes it to form a water tight model. In one embodiment, rectifying the model in step 400 may also include closing a hole at the end of an extrusion. An alternative to extruding is simply to shell the 2½D surface to produce data that has some thickness for building.

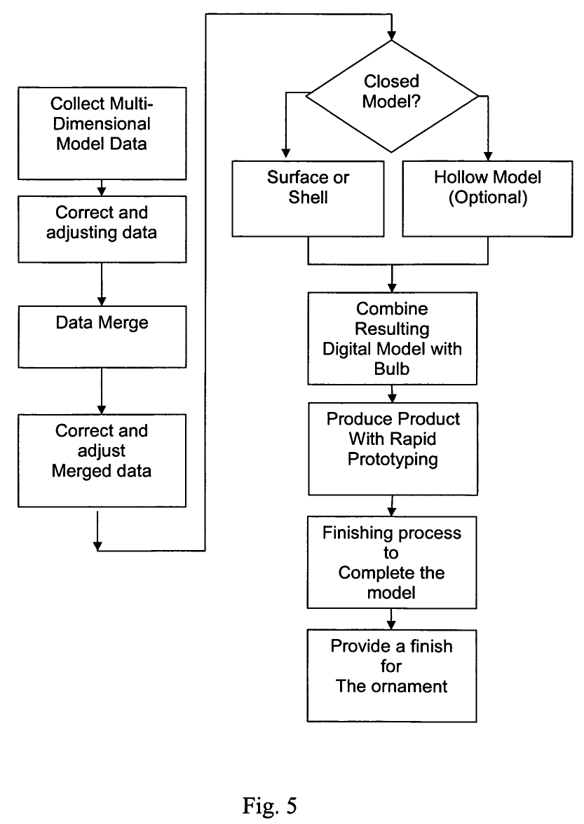

The sculpture is prepared for building in step 500. There are several ways to prepare the sculpture 500 for building which is dependent on what the desired properties of the sculpture as shown in FIG. 5. However, if not already done, the digital data must be moved into a form that has some volume to be built. If the model is a closed model, preparing the sculpture 500 may include the need to shell and hollow the model and then digitally cut an opening in the model to allow the unused build matter out which minimizes the weight and to reduce the amount of build material that is used. This process dramatically reduces the cost to build.

For models that are not a full 360 degree representation, the model is prepared in step 500 by extruding, hollowing and then digitally removing the back (extruded portion) of the model, creates a sculpture that could hold water like a bowl if desired. Alternatively if the model is not closed or is simply a surface it can be prepared in step 500 by shelling to produce an object of some thickness for building. Thus preparing the sculpture 500 may also include the process of hollowing. The function of hollowing and shelling (in some cases) a model are often used to reduce weight and cost of production. Shelling provides several functions. Shelling makes a contour buildable by giving the model a thickness. Shelling also places a shell inside a closed object to essentially provide a hollow. It is realistic to believe that there are situations where there may be sufficient justification for the production of solid builds.

In other embodiments, preparing step 500 may also creates a hole in the 3D digital model to allow for an insert such as a light bulb. Furthermore, during the preparation of the sculpture in step 500, the sculpture may be merged with other digital sculptures such as a husband combined with wife to make a complete sculpture or it may also be merged with inanimate objects such as trees, boxes, balloons or other to form the final 3D sculpture representation for build.

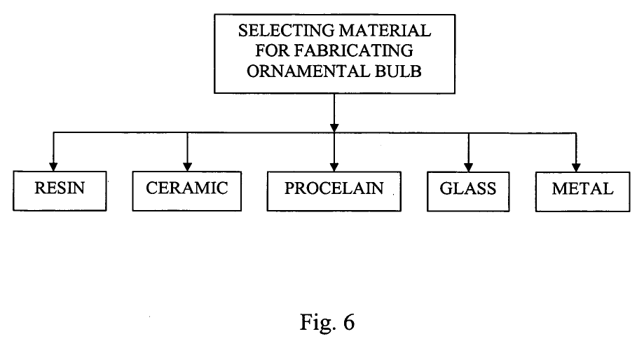

Once the adjusted data corresponding to the collected data is prepared, the adjusted data from step 500 for the sculpture and the data corresponding to the ornamental bulb are combined in step 600. Combining 600 the bulb data and sculpture data may performed by various processes. In one embodiment, combining 600 is a digital combination of the digital sculpture of the bulb with the digital design of the bulb. This combined model is used for certain applications and affects such as when a foot protrudes from the object or it is desired to build a bulb that the sculpture could not otherwise be inserted or simply because the desired build is a monolithic build where the bulb is created at the same time as the sculpture. In another embodiment, combining step 600 builds and finishes the sculpture then attaches the sculpture to an existing bulb. In FIG. 6 the existing bulb can be fabricated from many kinds of material. Typical material used to fabricate the ornamental product is ceramic, glass, porcelain, metal, composite, or resin.

Producing the ornamental product is accomplished in step 700. In an embodiment, the producing step uses rapid prototyping, although alternative methods of rapid manufacturing will be obvious to those skilled in the art. For purpose of illustration and discussion, and not limitation, the method of the present invention is described using rapid prototyping. There are many suppliers of rapid prototyping (RP) devices or equipment and there are also many variations. By way of example, RP devices include Stereolithography (SLA), Solid Ground Curing (SGC), Laminated Object Manufacturing (LOM), Fused Deposition Modeling (FDM), Selective Laser Sintering (SLS), Ballistic Particle Manufacturing (BPM), 3D Printing and Deposition Milling (3DP), and Direct Shell Production Casting (DSP). Within the spirit of the invention, injection molding technology also provides another alternative means to produce an ornamental product.

Presently, few suppliers provide the ability to create full color models directly from the RP process. Z-Corp is one such supplier that sells a fully color capable system. Combining scanning technologies with RP is often referred to as reverse engineering and rapid manufacturing. The data manipulation process is referred to as DSSP (Digital Shape Sampling and Processing). In one embodiment, producing step 700 utilizes a Z-Corp Spectrum 510 3D printer for production, which provides relatively affordable full color products. In other embodiments, any number of RP machines can be used including Computerized Numerical Controlled (CNC) milling for the sculpture itself.

Finishing the ornamental product in step 800 is predominately the final process of the RP manufacturing process. However, there are some unique and specialized techniques that are administered to achieve an appropriate and appealing final ornamental bulb. Using a typical RP various embodiments include finishing processes 800 such as cleaning of any unwanted foreign debris, brushing or sanding if so desired, heating or baking the product to strengthen and prepare for infiltration, infiltrating or coating the product with hardeners or finishes. In yet other embodiments, finishing 800 may include trimming if there is a need to remove unwanted artifacts or to make it fit properly, hand painting or inscribing if desired, or drilling holes and affixing attachments.

In summary, the present invention provides methods, apparatus and systems to a method of collecting three-dimensional data from one or more sensors, adjusting the 2½D or 3D data, merging the 2½D or 3D data to produce a 2½D or 3D model, rectifying the model, preparing the sculpture for building, combining the sculpture data with a bulb data, producing a personalized ornamental product from the combined data with a rapid prototype device, and finishing the product.

As to alternative embodiments, those skilled in the art will appreciate that the present method for producing a personalized ornamental object can include an ornamental bulb for hanging or standing, or may be a vase or other vessel. Likewise, although the method of forming the ornamental object and three-dimensional sculpture monolithically has been described as a hollow decorative ornamental bulb having a three-dimensional sculpture of a person, the sculpture may be of an animal or other living being and the completed personalized ornamental product may be a keepsake product for remembering a loved one.

It is apparent that there has been described a method for producing a personalized ornamental object that fully satisfies the objects, aims, and advantages set forth above. While the method for producing a personalized ornamental object has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

We claim:

1. A method for fabricating a personalized ornamental product comprising the steps of:
collecting three-dimensional data of an object using a sensing device;
adjusting the three-dimensional data;
merging the collected three-dimensional data with the adjusted data to produce a three-dimensional model data of the object;
rectifying the three-dimensional model data;
combining the three-dimensional model data with a three dimensional ornamental object data;
producing the personalized ornamental product from the combined model data and ornamental object data; and
finishing the personalized ornamental product.

2. The method in claim 1, wherein the object scanned is selected from the group consisting of people, animals, pets, and personal property.

3. The method in claim 2, wherein the collecting step utilizes a structured light scanner.

4. The method in claim 3, wherein the three-dimensional data includes a first object data and a second object data, the adjusting three-dimensional step comprises:
eliminating a first object data from the three-dimensional data.

5. The method in claim 4, wherein the adjusting colors step comprises the step of:
matching a boundary area between three-dimensional data to close the three-dimensional model; and
changing data corresponding to colors within the three-dimensional data to match deficiencies within a production process.

6. The method in claim 1, wherein the merging step combines at least two sets of adjusted three-dimensional data into a single model.

7. The method in claim 1, wherein the three-dimensional model data includes a first surface data and a second surface data, the rectifying step comprises:
removing the first surface data from the three-dimensional model data.

8. The method in claim 7, further comprising:
extruding edges of a two and one-half dimensional model to close the ornamental product; and
closing an extrusion hole.

9. The method in claim 1, wherein the rectifying step comprises the step of:
modifying the three-dimensional model data to provide an additional thickness to a surface of the ornamental product.

10. The method in claim 9, further comprising:
hollowing the three-dimensional model; and
digitally cutting back an extruded portion of the three-dimensional model.

11. The method in claim 10, further comprising the step of creating a hole within the three-dimensional model.

12. The method in claim 1, wherein the combining step is a digital combination of the sculpture and the bulb.

13. The method in claim 12, wherein the combining step comprises:
building the sculpture and bulb, the bulb having a view opening; and
sizing the sculpture to a size larger than the view opening.

14. The method in claim 13, wherein the building step includes providing a protrusion extending from the sculpture through the bulb.

15. The method in claim 12, wherein the combining step comprises:
building the sculpture;
finishing the sculpture; and
attaching the sculpture to an existing bulb.

16. The method in claim 13, wherein the ornamental product is fabricated from the group consisting of porcelain, ceramic, glass, metal, and resin.

17. The method in claim 16, wherein the producing step is a selected from the group consisting of stereolithography, solid ground curing, laminated object manufacturing, fused deposition modeling, selective laser sintering, ballistic particle manufacturing, 3D printing and deposition milling, injection molding, and direct shell production systems.

18. The method in claim 1, wherein the finishing step comprises:
coating the ornamental product with a hardening substance; and
heating the ornamental product.

19. The method in claim 17, wherein the finishing step is inscribing text on an exterior surface of the personalized ornamental product.

20. The method in claim 19, wherein the inscribing step is selected from the group consisting of numbering, serial numbering, signing, autographing, dating, and event identifying.
